(19) United States
(12) Patent Application Publication
(10) Pub. No.: US 2011/0110177 A1
(43) Pub. Date: May 12, 2011

(54) System for producing asphalt from reclaimed asphalt pavement

(76) Inventor: Wesley Van Velsor, Charlestown, NH (US)

(21) Appl. No.: 12/924,115

(22) Filed: Sep. 21, 2010

Related U.S. Application Data
(63) Continuation-in-part of application No. 11/805,021, filed on May 22, 2007.
(60) Provisional application No. 60/802,360, filed on May 22, 2006.

(51) Int. Cl. B28C 5/36

(52) U.S. Cl. 366/22

(57) ABSTRACT

A system for producing asphalt from RAP including a conveyor belt, a source of fuel, at least one infrared chamber, at least one rotary mixer, and an asphalt producing module, preferably a drum heater. The system includes measures for carefully controlling the heat of the reclaimed asphalt pavement as it is dried, including controls for adjusting the distance between the infrared chambers and the conveyor belt, controls for turning each individual infrared chamber on and off, and controls for adjusting the rate of the conveyor belt and the rotary mixers.

### CLAIM OF PRIORITY

This application is a continuation in part of co-pending U.S. Non-Provisional patent application Ser. No. 11/805,021, filed on May 22, 2007, and claims the benefit of priority of U.S. Provisional Patent Application Ser. No. 60/802,360, filed on May 22, 2006.

### FIELD OF THE INVENTION

The present invention relates to the field of asphalt manufacturing and, in particular, to a reclaimed asphalt pavement (RAP) pre-heating system for pre-heating RAP being conveyed into asphalt manufacturing modules during the asphalt manufacturing process.

### BACKGROUND OF THE INVENTION

The creation and maintenance of millions of miles of roads depend on asphalt production. In today's industry, there is great emphasis on using recycled or reclaimed asphalt pavement (“RAP”). It reuses existing materials, rather than requiring the quarrying of new aggregate materials. It also has the advantage of already having some asphalt content, thus lowering the amount of asphalt needed to make a new finished product. In these respects, it is both economical and green. Using RAP presents challenges not present with traditional asphalt production, however. Specifically, although the RAP must be heated to at least 212° F. for the moisture to be released from the aggregate, as RAP contains asphalt, it can only be heated to a certain extent before the asphalt ignites around 375-400° F. As traditional asphalt production generally involves aggregate materials such as rock and sand, before the asphalt is introduced to the mix, there was not such a need for temperature control. Demand for asphalt that is 25-50% RAP is common now, but given the challenges inherent in using RAP, it is difficult to raise the percentage above 15%-25%. As demand for, and interest in, RAP grow, production systems with better heat control are necessary.

The raw material for roadway asphalt, known in the industry as Hot Mix Asphalt (“HMA”), is usually prepared at a batch or drum plant. In addition to the asphalt oil itself, HMA includes an aggregate, which is typically a mixture of sand, small rocks, and other filler material, such as shredded rubber tires, or may be RAP that is crushed into small pieces. This aggregate used in the manufacturing process invariably has moisture entrapped therein, which must be removed before the asphalt oil is added.

Conventional HMA plants include a conveyor belt upon which aggregate is conveyed into a rotating drying drum, which may include impellers to lift the aggregate to assist in the drying process. The drum is typically rotated and heated to a very high temperature. Heating is typically accomplished by firing an oil burner and using a fan located adjacent to the drum to direct a flow of hot air into the drum. The aggregate is tumbled in the hot air flow by the rotation of the drum, and by the impellers lifting the aggregate and dropping it into the air stream, essentially drying and heating the aggregate. Once the aggregate is heated to a desired temperature, typically in the range of 120-180° C., the aggregate is sufficiently dried and a flow of hot liquid asphalt is introduced to the aggregate, and mixed therewith, producing the finished HMA.

The process employed by conventional HMA plants is effective at drying and heating the aggregate and generally produces an acceptable end product. However, this process has three substantial drawbacks.

First, the burners used to heat the aggregate during the drying and pre-heating process use an enormous amount of fuel, which is costly both in terms of purchasing the oil and in terms of controlling the emissions produced thereby. Therefore, the longer these burners are forced to run, the greater the expense of producing the HMA. Unfortunately, even with the use of impellers to mix the aggregate during drying, bulk drying of the entire batch of aggregate at one time is inefficient and results in the burners being fired for a significant period of time to effect drying, resulting in a significant amount of expensive fuel being used and causing unnecessary emissions.

Second, the longer the drying process takes, the fewer batches of HMA that may be produced. Because the equipment used in HMA production is very expensive, and because the demand for HMA is such that all batches produced by a given plant would be readily sold, increasing the rate at which batches of HMA may be processed will greatly increase the profits for HMA manufacturers.

Third, the amount of aggregate used in each batch produced by the HMA manufacturing process is typically measured by the weight of the aggregate in the drying drum. Therefore, variations in the moisture content of the aggregate can cause the amount of aggregate to be too low. Thus, the manufacturer is forced to either live with these variations, resulting in batch-to-batch inconsistencies of the HMA produced, or to add more wet aggregate to the drum, which further increases the amount of fuel used and drying time.

In addition to HMA, a number of companies have recently developed formulations for Warm Mix Asphalt (WMA) to replace traditional HMA. WMA is manufactured using a process similar to BMA, but uses different formulations of aggregate and asphalt additives that are each mixed at lower temperatures than HMA. Switching from HMA to WMA reduces the amount of fuel used in the manufacturing process, as it is heated to lower temperatures than HMA, and allows the use of certain additives that cannot withstand the temperatures required during the production of HMA. Further, WMA has been found to reduce the curing time of the asphalt, allowing a shorter period of time between laying the asphalt surface and allowing the pavement to be used.

A number of tests on WMA have produced encouraging results. However, a recent report by the National Center for Asphalt Technology cautioned that the moisture content of the mix is an important consideration and cites the potential for moisture damage due to too much water left in close content with the aggregate. Thus, there is a need for a means for pre-drying the aggregate used in WMA production in order to reduce the chance of moisture damage.

At least two systems currently exist for drying particulate matter, such as aggregate, using a heating element over a conveyor belt. The first system is disclosed in U.S. Pat. No. 4,136,964 to Swisher. This is an apparatus for simultaneously mixing and conveying particulate material, the apparatus comprising a housing having an input end and an output end disposed vertically higher than the input end, means for feeding the particulate material into the input end of the housing, a conveyor disposed within the housing and having a plurality of lifting surfaces provided with perforations therethrough so that a portion of the particulate material being lifted by each lifting surface descends through the perforations and is mixed with particulate material being lifted by lifting surfaces disposed therebelow, and, means for discharging the mixed particulate material from the output end of the housing.

The housing of the mixer/conveyor is provided with at least one opening through the upper wall section thereof to facilitate the introduction of heated exhaust gases produced by an associated burner assembly connected thereto. Each burner assembly is comprised of a housing having suitable refractory material lining the inner surfaces thereof, and an oil or gas fired burner of the conventional construction. Hydrocarbon fuel for the burner will be supplied in a conventional manner from a suitable source of fuel, while combustion-supporting air is preferably supplied by a blower assembly via an air duct. An adjustable draft, exhaust damper assembly should also be connected to the output end of the housing to facilitate control of the pressure in the mixer/conveyor as well as to direct the heated exhaust gases exiting from the housing.

Although capable of drying particulate matter, this system, and its burner assembly in particular, is ill suited for portability. First, the mixer/conveyor and burner assembly are bulky because they are completely enclosed so that the heated exhaust gases may flow across the material to be dried. This bulk cannot be diminished to provide better portability without thwarting the burner assembly's heating capabilities. Moreover, doing so, especially in the field, would cause the introduction of the exhaust gases into the atmosphere. Second, in part because of the system's bulk, it is difficult to set up and break down, which is a key aspect of portability. Given the size and weight of the various assemblies that make up the system, a crane is necessary to position the assemblies. A crane is another large vehicle, requiring a skilled operator, which would have to come out to the site, greatly increasing the cost and carbon emissions of using the system.

The second currently existing system for drying particulate matter, such as aggregate, using a heating element over a conveyor belt is disclosed in U.S. Pat. No. 5,557,858 to Macaluso et al. This system is an infrared wood product dryer apparatus including an enclosure structure defining an interior, a conveyor assembly configured for conveying a particulate material along a material flow path through the interior substantially between an inlet and an outlet, an array of infrared radiant energy sources configured for exposing the material to infrared radiant energy while it is conveyed along the path, and a series of agitators configured for agitating the material in order to increase the exposure of the material to the infrared radiant energy. A gas recirculation assembly is provided to direct a heated interior gas onto the material in order to convection-dry the material. An exhaust assembly reduces the moisture content of the interior gas by drawing a quantity of the gas from the dryer so that fresh gas having a lower moisture content may be drawn into the dryer.

This system is also capable of drying particulate matter, but is also ill suited for portability. First, as a practical matter, the inlet to which material to be dried is introduced to the system is at the top of the system, so that material must be lifted up to be dried. This lifting up will likely require an added mechanical element, for the system to be used in the field. The more elements necessary for the system's use, the more costly and difficult it becomes to use in the field. Moreover, portable systems need to be able to be driven around on a truck or other vehicle, and this system is too tall for that type of transportation. Any system that is going to be driven on roads needs to be fairly flat so that trucks can get through tunnels and other low passages while hauling the system. This system has at least three stacked layers of conveyor belts and heaters within the enclosure structure, making it quite tall, and thus unwieldy for road transportation.

Therefore, there is a need for a system for producing asphalt from RAP that effectively and safely dries and/or pre-heats RAP for use in HMA or WMA production.

### SUMMARY OF THE INVENTION

The present invention is a system and method for producing asphalt from RAP. In its most basic form, the system for creating asphalt from RAP includes a conveyor belt in communication with a source of RAP, at least one infrared chamber, a source of fuel, at least one mixer disposed between the infrared chamber and the conveyor belt, and a drum or batch heater or other blending device. The conveyor belt is preferably manufactured of a rubberized material that is adapted to convey the aggregate material at a predetermined rate. The infrared chamber, or chambers, is/are disposed in substantially parallel relation to the conveyor belt at a distance sufficient to allow infrared heating of the aggregate material. The fuel source is preferably a gaseous fuel, such as propane or natural gas, which is in communication with the infrared chamber. The mixer is dimensioned and disposed relative to the conveyor belt so as to mix the RAP during pre-drying.

In operation, the conveyor belt conveys the RAP from its source and under the infrared chamber at a predetermined, but adjustable, rate to a terminal end of the conveyor belt. The fuel flows to the infrared chamber, which burns the fuel causing the infrared chamber to emit infrared radiation therefrom. The infrared radiation contacts the top surface of the aggregate that is conveyed on the conveyor belt and acts to heat the top portion of the RAP proximate to the infrared chamber. The mixer then mixes the RAP such that heated and unheated RAP are mixed together, allowing the unheated RAP proximate to the conveyor belt to rise to the top surface proximate to the infrared chamber. The infrared radiation from the infrared chamber then heats the mixed RAP to effectively pre-heat and pre-dry the RAP.

The preferred heating system includes at least three, and preferably eight infrared chambers. The preferred infrared chambers include a solid aluminum top cover. Moisture escapes out of the upper end of the infrared chambers in the gaps between the chambers where the mixers are placed, as discussed below. The conveyor belt is preferably inclined so as to act as a chimney. In an alternative embodiment, the top portion of the infrared chamber is manufactured of expanded metal, which allows for the escape of such moisture. In still other embodiments, the chamber includes a plurality of holes formed therethrough to allow such moisture to be vented. Each infrared chamber includes a plurality of infrared converters.

The preferred heating system also includes at least one igniter assembly in communication with the infrared chamber. The igniter assembly is adapted to ignite the fuel within the infrared chamber so that it may be burned and turned into infrared radiation. The preferred embodiment utilizes multiple, individual igniter assemblies, which are each in communication with a single infrared chamber and are independently controlled by the control box. Each igniter assembly is itself in communication with the source of fuel, and includes two igniter rods, two sparker transformers with mounting plates, one flame sensor, a main gas valve, and a pressure switch. The rods are in communication with the infrared converters of the infrared chamber, so that the ignited fuel may travel into the converters. Having individual igniter assemblies for each infrared chamber, rather than a single igniter used to ignite the fuel within each of the chambers, is preferable as it allows individual infrared heaters to be turned off. This provides greater control over the heating of the system, which is particularly important when using RAP.

The mixers are placed between the infrared chambers so as to mix the RAP as it travels along the conveyor belt. The infrared chambers are preferably disposed in a row over the conveyor belt such that each infrared chamber is disposed relative to an adjacent infrared chamber so as to form a gap therebetween. One mixer is preferably disposed within each gap. One mixer is also preferably disposed at the end of the conveyor belt, after the last infrared chamber.

In the preferred embodiment for use with RAP, the mixer is a rotary mixer assembly. This preferred mixer is a bolted roller with 5″ diameter disposed across the conveyor belt. The roller includes six evenly spaced bolts protruding from cross sections spaced 2″ apart down the length of the pipe, with every other set of bolts being offset from the sets of bolts on either side of it. In the preferred embodiment, the mixers are individually controlled as to how fast they rotate, and thus mix the aggregate.

In another embodiment, the mixer is a series of ramps that are disposed proximate to the conveyor belt. Each ramp has a ramp surface that is disposed at an angle from the plane formed by the conveyor belt and is dimensioned to allow the asphalt aggregate to be pushed up the ramp by aggregate that is in contact with the conveyor belt and to tumble back onto the belt, effectively mixing the aggregate. This embodiment is not preferred because the preferred incline of the conveyor belt leads to damming of the aggregate material at the mixers.

In another embodiment, the mixing is a result of multiple conveyor belts that are spaced to allow the aggregate material to tumble from one conveyor belt to the adjacent conveyor belt. Once tumbled, the aggregate material is further mixed by moving through the tines of a mixer as described below. This embodiment is not preferred as the multiple conveyor belts, each with separate mechanics, drive up the cost of the system.

In some embodiments, the mixers include a plurality of tines forming a plurality of spaces therebetween, and each is dimensioned and disposed within each gap such that each tine of one mixer is aligned with a space of adjacent mixers. In this manner, the aggregate is thoroughly mixed rather than just having the areas adjacent to the tines mixed. This embodiment is not preferred for use with RAP because it has been found that it does not release moisture from the aggregate as well as the mixers mentioned above.

In other embodiments, the mixer includes a channel, and a plurality of tines rotatably attached to the channel. The tines are in communication with at least one spring and are disposed in sufficiently close proximity to the conveyor belt so as to contact the aggregate material conveyed by the conveyor belt. The spring allows the tines to flex while preventing them from becoming entangled with the conveyor belt. In this embodiment, the tines may be joined together into a rake and a single spring is used to maintain the tines in position. However, in other embodiments, each tine is independent from the other tines and is in communication with its own spring. These embodiments are also not preferred for being less efficient at moisture release.

In the preferred embodiment, an area at the end of the conveyor belt includes multiple smaller mixers disposed between the conveyor belt and the infrared chambers. This area is preferably the length of two infrared converters down the conveyor belt, but may be less or more area of the conveyor belt. The small mixers are preferably similar to the preferred bolted rollers discussed above, but smaller in diameter and the length of the protruding bolts. These small mixers may be directly adjacent to one another, rather than distanced by the length of an infrared chamber. They may also be periodically spaced between the larger mixers that are spaced between each infrared chamber. The speed at which the small mixers rotate is also preferably controllable, and is preferably faster than the speed of rotation of the large mixers. These mixers protect against ignition of the asphalt within the RAP by ensuring even distribution of heat throughout the aggregate when the RAP is at its hottest at the end of the conveyor belt.

The preferred embodiment includes further heat control measures to safeguard against asphalt ignition. Specifically, the second to last space above the conveyor belt for an infrared chamber is preferably occupied not by an infrared chamber, but by a heat reflector that will reflect back the heat of the aggregate, but not introduce additional heat. There is also preferably a thermometer or other heat sensor between the heat reflector and the last infrared chamber that indicates the temperature of the aggregate at that point. The last infrared chamber will be activated if the aggregate is not near temperatures at which the asphalt is likely to ignite. Alternatively, it will remain dormant, without adding additional heat to the aggregate if the aggregate is near temperatures at which the asphalt is likely to ignite. Although this is the preferred embodiment, it is understood that all spaces may be filled with infrared chambers, and that heat reflectors may be substituted for one or more heat chambers in any of the positions along the conveyor belt. Finally, at least the last infrared chamber at the end of and above the conveyor belt, but preferably all infrared chambers above the length of the conveyor belt are adapted to move up and down to increase or decrease the distance between the infrared chambers and the conveyor belt. Furthermore, as discussed above, as each infrared chamber includes a designated igniter, it is possible to turn each individual infrared chamber on and off as desired.

The preferred embodiment of the present invention also includes a drum heater disposed at the terminal end of the conveyor belt such that the dried RAP is deposited into the drum heater. The drum heater may be substituted with a pugmill. For HMA, the drum heater adds liquid asphalt as needed to the dried and heated RAP and mixes all to form new asphalt. For WMA, the drum heater adds the requisite additives and mixes the all to form new asphalt. It is preferred that the drum heater include additional external heaters around the exterior of the drum heater to provide additional heat in the asphalt producing process.

Some embodiments of the heating system of the present invention include at least one hygrometer and/or thermometer for determining the moisture content and/or temperature of the aggregate at least at the start of the pre-heating process. In such embodiments, the hygrometers and/or thermometers are preferably in communication with a conveyor control, which slows the conveyor belt or speeds up the conveyor belt based upon the amount of moisture within the aggregate. Thus use of such a control is preferred when the system is used in connection with WMA manufacturing as it allows for careful control of the amount of moisture while maximizing the speed of the process in instances where there are minimal amounts of moisture within the aggregate.

The preferred heating system includes a control box in electrical communication with the infrared chamber and the source of fuel. The control box includes controls for controlling several system functions, including the operation of each individual igniter assembly, the flow of fuel from the source to the infrared chambers, blower motor operation, conveyor belt speed control, large mixer rotation speed controls, small mixer rotation speed controls, and infrared chamber elevation controls.

The preferred heating system also includes at least one blower motor in communication with the control box, the source of fuel, a source of air, and the infrared chamber. The blower motor is controlled by the control box and is adapted to mix fuel and air together and force the mixture of fuel and air into the infrared chamber. The use of a blower motor is preferred as it allows the infrared chamber to consistently produce a greater amount of heat than may be produced by relying upon the pressure from the source of fuel.

The system and method of the present invention are very well suited for use with RAP. As described above, several heat controlling measures, such as adjustable elevation of the infrared chambers, individual controls for each infrared chamber, temperature sensors, additional mixers, and the strategic substitution of heat reflectors for infrared chambers in certain places make these systems much safer to use with RAP. As temperature is well controlled, the possibility of igniting the asphalt inherent in the RAP is lessened, if not eliminated. Moreover, the preferred mixer for these systems and the preferred positioning of the conveyor belts at an incline allow for optimal moisture release from the RAP, which commonly has high moisture content at the outset.

Therefore, it is an aspect of the invention to provide a system for safely and effectively pre-heating and pre-drying RAP during asphalt production.

It is a further aspect of the invention to provide systems capable of controlling the heat during RAP drying so that the asphalt in RAP does not ignite.

It is a further aspect of the invention to provide a system capable of reaching the optimal temperatures for asphalt production.

It is a further aspect of the invention to provide a reflector used in connection with heaters in order to focus heat downward onto the RAP.

It is a further aspect of the invention to provide a system and method to reduce the risk of moisture damage due to the presence of excess moisture in RAP used in the production of WMA.

These aspects of the invention are not meant to be exclusive and other features, aspects, and advantages of the present invention will be readily apparent to those of ordinary skill in the art when read in conjunction with the following description, appended claims and accompanying drawings.

### BRIEF DESCRIPTION OF THE DRAWINGS

FIG. 1 is a side view schematic of a preferred embodiment of the system of the present invention.

FIG. 2A is a perspective view of the preferred bolted roller mixer of the present invention.

FIG. 2B is a cross section view of the preferred bolted roller mixer of the present invention.

FIG. 3 is a side view of the preferred infrared chamber of the present invention.

FIG. 4 is a top view of the preferred embodiment of the heating system of the present invention.

FIG. 5 is block diagram showing the functions controlled by the preferred control box of the present invention.

### DETAILED DESCRIPTION OF THE INVENTION

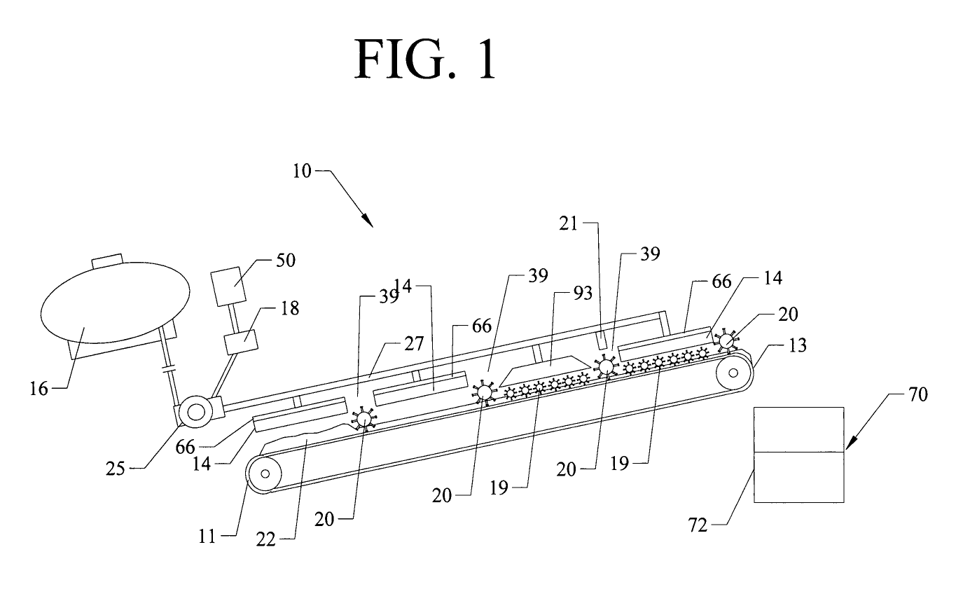

Referring to FIG. 1, a side view schematic of a preferred embodiment of the system 10 of the present invention is shown.

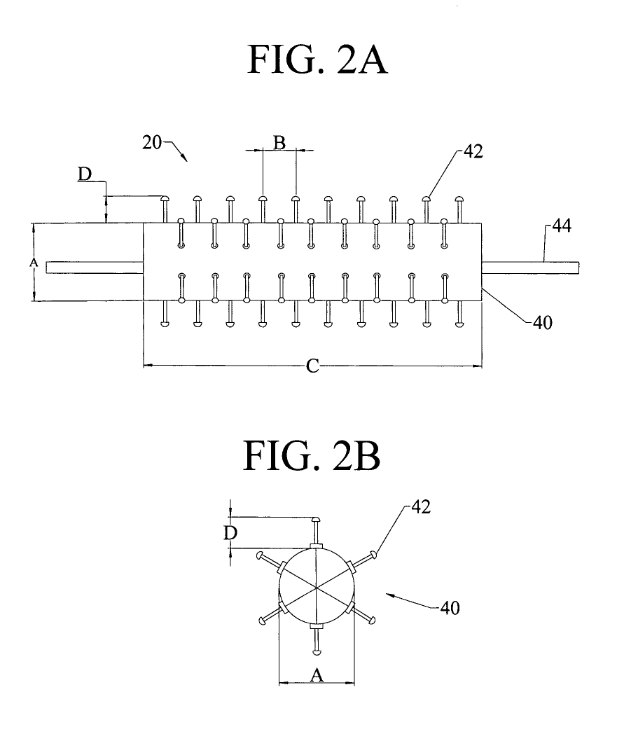

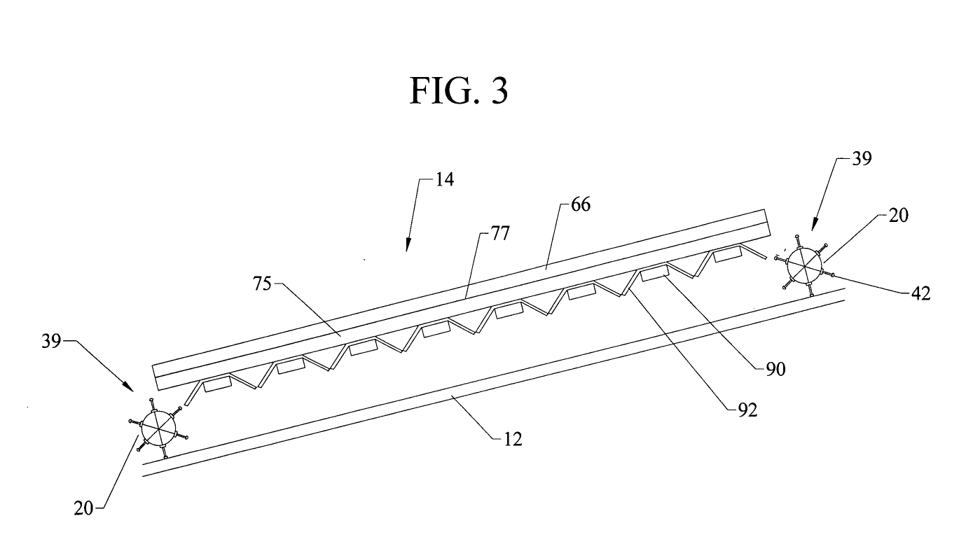

The system 10 includes a conveyor belt 12 in communication with a source (not shown) of the RAP 22. The conveyor belt 12 has a first end 11, where RAP 22 is first deposited onto the conveyor belt 12, and a terminal end 13, where the dried and heated RAP 22 leaves the conveyor belt 12 and is deposited into asphalt producing module 70. The conveyer belt 12 preferably takes the form of conveyor belts currently used to transport aggregate material in conventional HMA and WMA manufacturing processes. The belt may be manufactured of a non-combustible material, such as steel, but is preferably a composition belt manufactured of a rubberized material. Such a material is preferred due its gripping properties and price. The conveyor belt 12 is adapted to convey the RAP 22 at a predetermined rate from the source to the asphalt production module 70. The conveyor belt 12 is preferably in an inclined position, up to a four to one incline, to facilitate the chimney like aspects of the aluminum top portion 77 (shown in FIG. 3) of each infrared chamber 14. However, the conveyor belt 12 may also be substantially horizontal, as shown in FIG. 2. As discussed below, the conveyor belt 12 may include controls to allow the rate of the conveyor belt 12 to be varied based upon the moisture content or temperature of the RAP 22.

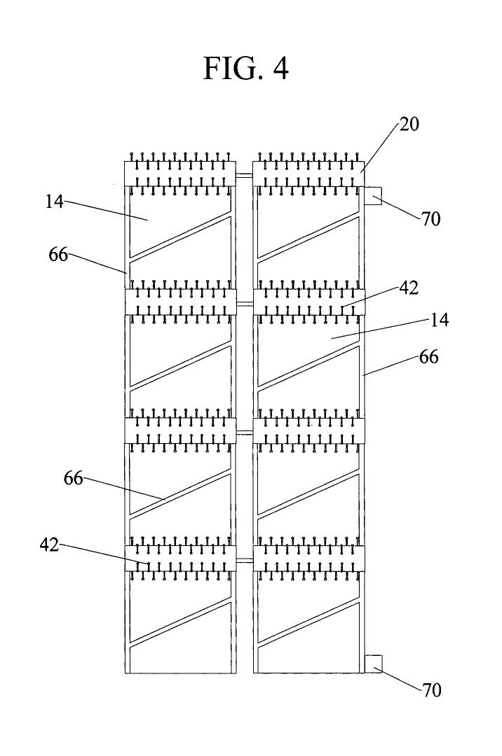

The system 10 also includes at least one infrared chamber 14. In the embodiment of FIG. 1, the distance over conveyor belt 12 is covered by three infrared chambers and one heat reflector 93. It is preferable that the penultimate structure above the conveyor belt 12 toward its terminal end 13 be heat reflector 93, and the ultimate structure be an infrared chamber 14 as shown, but it is understood that all spaces may be occupied by infrared chambers 14 and that more than one heat reflector 93 may be positioned over the conveyor belt 12 and may be so positioned at any position, not exclusive of the penultimate position. Moreover, in other embodiments of the system 10, greater or fewer infrared chambers 14 may be utilized. The preferred embodiment, however, includes seven infrared chambers 14 and one heat reflector 93 in the penultimate position. The infrared chambers 14 and heat reflector 93 are preferably 8′×3′. Heat reflector 93 is made of a heat reflective material, preferably aluminum. The infrared chambers 14 and heat reflector 93 are mounted in substantially parallel relation to the conveyor belt 12 and are disposed at a distance above the conveyor belt 12, preferably four inches, sufficient to allow infrared radiation to penetrate into the RAP 22. The distance between the infrared chambers 14 or heat reflector 93 and the conveyor belt 12 may be adjusted as a control for the amount of heat applied to the RAP 22. The infrared chambers 14 are dimensioned to extend over the entire width of the conveyor belt 12 and are manufactured in different sizes to accommodate different widths of conveyor belts 12; typically thirty, thirty-six, sixty and seventy-two inches. As shown in FIG. 4, in instances where sixty or seventy-two inch wide conveyor belts 12 are utilized, two infrared chambers 14 or heat reflectors 93 may be mounted in side by side relation to one another to cover the width of the conveyor belt 12.

The infrared chambers 14 are in communication with a source of fuel 16, preferably propane but natural gas may also be used. When natural gas is used, the gas must be introduced to the infrared chambers 14 at a higher pressure than when propane is used, but no modifications to the hardware of the system are necessary to use natural gas instead of propane. In the embodiment of FIG. 1, fuel 16 is forced into the infrared chambers 14 by a blower motor 25. The blower motor 25 mixes fuel 16 with air and delivers the mixture, under pressure, through the manifold 27 to igniter assemblies 66. The preferred embodiment utilizes multiple, individual igniter assemblies 66, which are each in communication with a single infrared chamber 14 and are independently controlled by the control box 18. Each igniter assembly 66 is itself in communication with the source of fuel 16 through the manifold 27, and includes two igniter rods (one of which is shown from the side), two sparker transformers with mounting plates, one flame sensor, a main gas valve, and a pressure switch (the rest of which are not shown). The rods are in communication with the infrared converters 90 of the infrared chambers 14, so that the ignited fuel may travel into the converters 90, and provide uniform heating. Having individual igniter assemblies 90 for each infrared chamber 14, rather than a single igniter used to ignite the fuel 16 within each of the chambers 14, is preferable as it allows individual infrared chambers 14 to be turned off. This provides greater control over the heating of the system, which is particularly important when RAP is being used as the aggregate.

The preferred blower motor 25 also includes a shut off valve (not shown) to shut off the flow of fuel 16 to the infrared chambers 14. A control box 18, which is in electrical communication with the blower motor 25 and a source of power 50, preferably controls the operation of the blower motor 25. Source of power 50 is capable of powering the control box 18 and the mechanical elements of system 10. As described with reference to other embodiments, the control box 18 may also include other controls, such as ignition controls, speed controls for the conveyor belt 12 and mixers 20, 19, and elevation controls for the infrared chambers 14. The use of a blower motor 25 and control box 18 is preferred as it allows the infrared chamber 14 to consistently produce a greater amount of heat than may be produced by relying upon the pressure from the source of fuel 16 alone. However, in other embodiments, both the blower motor 25 and control box 18 are eliminated and the flow of fuel 16 to the infrared chambers 14 is controlled via a manually operated valve (not shown), which opens to allow fuel 16 to flow solely via pressurization from the fuel source and is closed to shut off flow completely.

At least one large mixer 20 is disposed between the infrared chambers 14 and the conveyor belt 12. The large mixer 20 is dimensioned and disposed relative to the conveyor belt 12 so as to mix the aggregate material 22 during pre-drying. The large mixer 20 contacts the aggregate material 22 and mixes the hot top layer with the cool lower layer to form a substantially homogenous mixture. The infrared chambers 14 and heat reflector 93 are disposed so as to form a gap 39 therebetween. A large mixer 20 is preferably disposed within each gap 39. A final large mixer 20 is disposed at the terminal end 13 of conveyor belt 12. The large mixer 20 is described in more detail with reference to FIGS. 2A and 2B.

Small mixers 19 are preferably included under the heat reflector 93 and infrared chamber 14 closest to the terminal end 13 of the conveyor belt 13, but may be spread throughout the length of conveyor belt 12. The small mixers 19 are preferably similar in both shape and function to the large mixers 20 discussed above and in more detail with reference to FIGS. 2A and 2B, but smaller in diameter and the length of the protruding bolts. The small mixers 19 may be directly adjacent to one another, rather than being spaced between infrared chambers 14 as are the large mixers 20. The speed at which the small mixers 19 rotate is also preferably controllable, and is preferably faster than the speed of rotation of the large mixers 20. The small mixers 19 protect against ignition of the asphalt within the RAP by ensuring even distribution of heat throughout the RAP when the RAP is at its hottest on the conveyor belt 12. In general, at the point in the drying/heating process when the RAP 22 reaches the small mixers 19, if an infrared chamber 14 is over the small mixers 19, the distance between the infrared chamber 14 and the conveyor belt 12 will be increased as a heat control measure. This elevation increase may be in response to a temperature reading from temperature sensor 21 preferably disposed between heat reflector 93 and the infrared chamber closest to the terminal end 13 of the conveyor belt 12. Temperature sensor 21 may be any temperature or heat measuring device that can withstand the heat at the end of the conveyor belt 12, such as a thermometer or thermal gun.

In operation, the conveyor belt 12 conveys the RAP 22 from its source and under the infrared chambers 14 at a predetermined rate. The fuel 16 flows to the infrared chambers 14, which burn the fuel 16 causing the infrared chambers 14 to emit infrared radiation therefrom. The infrared radiation contacts the top surface of the RAP 22 that is conveyed on the conveyor belt 12 and acts to heat the top portion of the RAP proximate to the infrared chambers 14. Large mixers 20 then mix the RAP 22 such that the heated and unheated layers of RAP 22 are mixed together, allowing the unheated RAP 22 proximate to the conveyor belt 12 to rise to the top surface proximate to the infrared chamber 14. The infrared radiation from the infrared chamber 14 then heats the mixed RAP 22 to effectively and safely pre-heat and pre-dry the RAP 22.

System 10 also includes asphalt producing module 70, which is preferably a drum mill 72, but may also be a pug mill. Asphalt producing module 15 may add at least one additive to the pre-heated and pre-dried RAP 22 that is deposited into asphalt producing module 15 by conveyor belt 12. The additive may be heated liquid asphalt for HMA production or the requisite additives for WMA production. The additive addition may be automated. The same asphalt producing module 15 may be used for either WMA or HMA. Asphalt producing module 15 then produces new asphalt from the RAP.

Referring now to FIGS. 2A and 2B, the preferred large mixer 20 is shown. The preferred large mixer 20 is a rotary mixer including a bolted roller 40 with 5″ diameter (diameter A) disposed around a pipe 44. The roller 40 includes six evenly spaced bolts 42, as shown in FIG. 2B, protruding from cross sections spaced 2″ apart down the length of the roller 40, with every other set of bolts 42 being offset from the sets of bolts 42 on either side of it, so that sets of bolts 42 that are not offset from one another are 4″ (distance B) apart. Each bolt 42 is preferably 3″ (height D) long. The preferred roller 40 is 40″ wide (width C). This is wide enough so as to cross the width of the preferred 3′×8′ infrared chamber 14 under and/or between the infrared chambers 14. When wide conveyor belts 12 are used, two or more of the large mixers 20 may be used side by side, as depicted in FIG. 4. In the preferred embodiment, the large mixers 20 are individually controlled as to how fast they rotate, and thus mix the aggregate material 22. Small mixer 19 is similar to large mixer 20, but diameter A is less than 5″ and height D is less than 3″.

Referring now to FIG. 3, a side view of the preferred infrared chamber 14 is shown. Although only large mixers 20 are depicted, it is understood that small mixers 19 may also be included in second space 82 between the conveyor belt 12 and infrared chambers 14. The preferred infrared chamber 14 includes eight infrared energy converters 90. These infrared energy converters 90 are preferably of the type manufactured by Ray-Tech Infrared Corporation of Charlestown, N.H., and described in connection with the inventor's U.S. Pat. No. 6,227,762. An angled reflector 92 is mounted about each infrared converter 90 such that the infrared energy generated by each converter is concentrated downward toward the conveyor belt 12. Angled reflector 92 is manufactured of a heat reflective material, preferably aluminum, and includes a body and a pair of wings extending downward from the body. Angled reflector 92 is similar to heat reflector 93, but heat reflector 93 is commensurate with an infrared chamber 14, while angled reflector 92 is approximately an eighth of the size of an infrared chamber 14, as each infrared chamber 14 preferably includes eight angled reflectors 92 for each of the eight infrared energy converters 90. Each infrared energy converter 90 is arranged in approximately perpendicular orientation from the direction of travel of the conveyor belt 12 and each infrared energy converter 90 is spaced slightly apart from an adjacent infrared energy converter 90 in order to allow a large mixer 20 to be disposed therebetween in first space 39. The preferred infrared chamber 14 includes a frame 75 and a top portion 77. Top portion 77 is preferably made of solid aluminum. Moisture escapes out of the upper end of the infrared chambers 14 in the gaps 39 between the infrared chambers 14 where the large mixers 20 are placed. The conveyor belt 12 is preferably inclined so as to act as a chimney to facilitate this moisture escape. FIG. 3 also shows a side view of the preferred igniter assembly 66, which shows one igniter rod from this view.

Referring now to FIG. 4, a top down view of another embodiment of the system 10 is shown. This embodiment shows an arrangement of eight infrared chambers 14 disposed in side by side relation and is used with wide conveyor belts 12, such as those that are 60″ or 72″ wide. In such instances, the infrared chambers may be mounted in side by side relation to one another to cover the width of the conveyor belt 12. Large mixers 20 with their bolts 42 as teeth are visible between the infrared chambers 14. The preferred igniter assembly 66 is also visible above the infrared chamber 14, including igniter rods on either side of the infrared chamber 14 and a tube stretching between them through which gas may pass between them, the tube preferably being placed diagonally across the middle of the infrared chamber 14. The igniter assembly 66 is adapted to ignite the fuel 16 within each infrared chamber 14 so that it may be burned and turned into infrared radiation.

The embodiment of FIG. 4 includes one hygrometer 70 for determining the moisture content of the RAP 22 at least at the start of the pre-heating process and another hygrometer 70 at the end of the pre-heating process. In such embodiments, the hygrometers 70 are in communication with a conveyor control (not shown), which slows the conveyor belt 12 or speeds up the conveyor belt 12 based upon the amount of moisture within the aggregate material 22. Thus use of such a control is preferred when the system is used in connection with WMA manufacturing as it allows for careful control of the amount of moisture while maximizing the speed of the process in instances where there are minimal amounts of moisture within the aggregate. In other embodiments, the hygrometer 70 is replaced by a thermometer, which measures the temperature of the aggregate material 22 and controls the speed of the conveyer belt 12 accordingly. In particular, as shown in FIG. 1, temperature sensor 21 is employed between heat reflector 93 and infrared chamber 14 to assess the temperature of the RAP 22 at that point. The area of the conveyor belt 12 closest to the terminal end 13 is where the RAP 22 will be at its hottest after having passed under a plurality of infrared chambers 14. When using RAP 22 as aggregate, it is particularly important that the temperature of the material be monitored and controlled to avoid ignition of the asphalt in the RAP. If temperature sensor 21 were to read a temperature at which there is a danger of ignition, then the final infrared chamber 14 could be elevated farther away from the conveyor belt 12, or shut off completely by turning off the dedicated igniter assembly 66 for that infrared chamber 14.

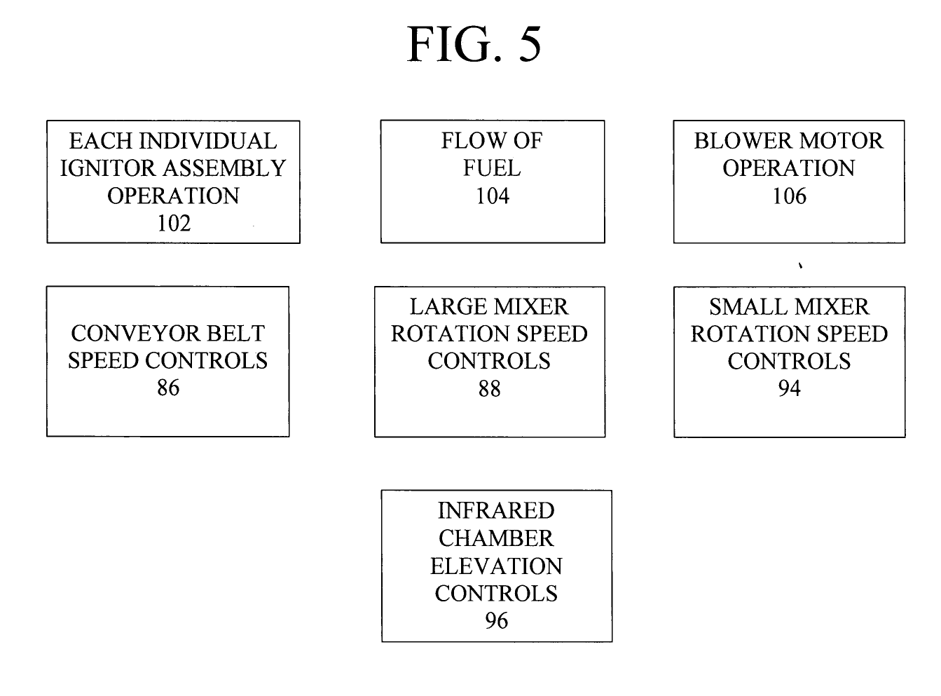

Referring now to FIG. 5, a block diagram showing the functions of the preferred control box 18 are provided. These functions include the operation of each individual igniter assembly 102, the flow of fuel 104 from the source to the infrared chambers, blower motor operation 106, conveyor belt speed control 86, large mixer rotation speed controls 88, small mixer rotation speed controls 94, and infrared chamber elevation controls 96.

Although the present invention has been described in considerable detail with reference to certain preferred versions thereof, other versions would be readily apparent to those of ordinary skill in the art. Further, although the heating system was developed for use in connection with aggregates used as paving materials, it is readily adapted for use with aggregates used for other purposes, such as livestock feed, or the like. Therefore, the spirit and scope of the appended claims should not be limited to the description of the preferred versions contained herein.

What is claimed is:

1. A system for producing asphalt from reclaimed asphalt pavement, said system comprising:
a conveyor belt having a first end and terminal end, in communication with a source of the reclaimed asphalt pavement, wherein said conveyor belt is adapted to convey the reclaimed asphalt pavement at a predetermined rate;
at least one infrared chamber disposed in substantially parallel relation to said conveyor belt at a distance sufficient to allow infrared heating of the reclaimed asphalt pavement, wherein the distance between said at least one infrared chamber and said conveyor belt is adjustable;
a source of fuel in communication with said infrared chamber;
at least one mixer disposed between said infrared chamber and said conveyor belt, said at least one mixer being dimensioned and disposed relative to said conveyor belt so as to mix the reclaimed asphalt pavement during pre-drying; and
an asphalt producing module disposed proximate to said terminal end of said conveyor belt such that the reclaimed asphalt pavement is provided to said drum heater, wherein said asphalt producing module is adapted to mix the RAP with at least one additive;
wherein said conveyor belt conveys the reclaimed asphalt pavement under said at least one infrared chamber, a fuel from said source of fuel flows to said at least one infrared chamber, said infrared chamber burns the fuel causing said at least one infrared chamber to emit infrared radiation therefrom, the infrared radiation heats a portion of the reclaimed asphalt pavement proximate to said infrared chamber, said at least one mixer mixes the reclaimed asphalt pavement such that heated and unheated reclaimed asphalt pavement are mixed together, the infrared radiation heats the mixed reclaimed asphalt pavement to effectively pre-dry the reclaimed asphalt pavement, the reclaimed asphalt pavement is deposited into said asphalt producing module, at least one additive is added to the reclaimed asphalt pavement within said asphalt producing module, and asphalt is produced.

2. The system as claimed in claim 1, wherein said conveyor belt is disposed at an incline up to four to one.

3. The system as claimed in claim 1, wherein the predetermined rate at which the RAP is conveyed is adjustable.

4. The system as claimed in claim 1, further comprising an igniter assembly designated to one of said at least one infrared chamber and adapted to ignite fuel from said source of fuel within said at least one infrared chamber and to be powered on and off at will.

5. The system as claimed in claim 1, wherein each of said at least one infrared chamber comprises a solid aluminum top portion.

6. The system as claimed in claim 1 further comprising at least one heat reflector disposed in substantially parallel relation to said conveyor belt at a distance at which heat emanating from the reclaimed asphalt pavement is reflected back onto the reclaimed asphalt pavement.

7. The system as claimed in claim 1, wherein said at least one mixer is a rotary mixer comprising a roller disposed about a pipe and bolts protruding from said roller at evenly spaced intervals, wherein said rotary mixer is adapted to rotate about said pipe.

8. The system as claimed in claim 7, wherein said roller is 5 inches in diameter and said bolts are 3 inches in length.

9. The system as claimed in claim 8 comprising at least two infrared chambers, wherein said at least one rotary mixer is disposed in a first space between said at least two infrared chambers.

10. The system as claimed in claim 7, wherein said roller is less than 5 inches in diameter and said bolts are less than 3 inches in length.

11. The system as claimed in claim 10, wherein said at least one rotary mixer is disposed in a second space between said at least one infrared chamber and said conveyor belt.

12. The system as claimed in claim 7, comprising at least two infrared chambers:
wherein said at least one mixer comprises at least one large mixer and at least one small mixer;
wherein said roller of said at least one large mixer is 5 inches in diameter and said bolts of said at least one large mixer are 3 inches in diameter;
wherein said roller of said at least one small mixer is less than 5 inches in diameter and said bolts of said at least one small mixer are less than 3 inches in diameter;
wherein said at least one large mixer is disposed in a first space between said at least two infrared chambers; and
wherein said at least one small roller is disposed in a second space between said at least two infrared chambers and said conveyor belt.

13. The system as claimed in claim 7, wherein the speed at which said rotary mixer rotates is adjustable.

14. The system as claimed in claim 1, wherein said asphalt producing module is a drum heater.

15. The system as claimed in claim 14, wherein said drum heater comprises external heaters disposed about the outside of said drum heater.

16. The system as claimed in claim 1, wherein the at least one additive mixed by said asphalt producing module is liquid asphalt for hot mix asphalt.

17. The system as claimed in claim 1, wherein the at least one additive mixed by said asphalt producing module are additives to form warm mix asphalt.

18. The system as claimed in claim 1 further comprising at least one thermometer adapted and disposed so as to detect a temperature of the reclaimed asphalt pavement.

19. The system as claimed in claim 1 further comprising at least one hygrometer adapted and disposed so as to detect an amount of moisture within the reclaimed asphalt pavement.

20. The system as claimed in claim 4 further comprising a control box:
wherein said at least one mixer is a rotary mixer adapted to rotate;
wherein said control box is in electrical communication with said infrared chamber, said source of fuel, said igniter assembly, said conveyor belt, and said at least one rotary mixer; and
wherein said control box comprising controls for:
the operation of each of said igniter assemblies;
the flow of fuel from said source of fuel;
the rate at which said conveyor belt conveys reclaimed asphalt pavement;
the rate at which said at least one rotary mixer rotates;
the adjustment of the distance between said at least one infrared chamber and said conveyor belt.
